(19) United States
(12) Patent Application Publication
(10) Pub. No.: US 2011/0252700 A1
(43) Pub. Date: Oct. 20, 2011

(54) HEAT INTEGRATED CHEMICAL COAL TREATING

(75) Inventors: Samuel David Draper, Simpsonville, SC (US); Shahryar Rabiei, Greenville, SC (US)

(73) Assignee: General Electric Company, Schenectady, NY (US)

(21) Appl. No.: 12/763,002

(22) Filed: Apr. 19, 2010

(51) Int. Cl. C10L 5/00; B01J 8/00

(52) U.S. Cl. 44/621; 422/621; 422/630

(57) ABSTRACT

Systems and methods are provided that include a heat integrated coal treating system having a two-stage coal treating process. In one embodiment, the two-stage treating process may include an HF reactor and an HNO₃ reactor coupled to the nitric acid reactor and having a fluid exchanging heat between the hydrofluoric acid reactor and the nitric acid reactor.

### BACKGROUND OF THE INVENTION

The subject matter disclosed herein relates to coal treating technologies and, specifically, to chemical treating, such as cleaning, of coal using acid leaching.

As will be appreciated, natural resources such as coal have a profound effect on modern economies and societies. Indeed, devices and systems that depend on coal as a direct or indirect source of energy are numerous. Coal may be used for fuel in a wide variety of processes. Further, coal is frequently used to heat homes during winter, to generate electricity, and to manufacture an astonishing array of everyday products.

As fossil fuel resources decrease and environmental concerns increase, the demands placed on the processing and use of coal and other natural resources and their effect on the environment have also increased. Particularly, the reputation of coal as a “dirty” fuel has led to new developments and processes for increasing the efficient use of coal as a fuel and for minimizing the environmental impact of such use. Many such technologies are generally referred to as “clean coal” technologies. One such coal treating process uses different acid leaching techniques to remove minerals from the coal.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a coal treating system, having a hydrofluoric acid reactor and a nitric acid reactor coupled to the hydrofluoric reactor, wherein a fluid heated by the nitric acid reactor is provided to heat the hydrofluoric acid reactor.

In a second embodiment, a system includes a control system configured to control a multi-stage coal treating system. The multi-stage coal cleaning system includes a first stage comprising a first leaching unit configured to perform a first acid leaching process with a first acid, a second stage comprising a second leaching unit configured to perform a second acid leaching process with a second acid and a heat transfer fluid flowing between the first stage and the second stage. Additionally, the control system controls the heating rate of the first stage, the second stage, or both, and the flow rate of the heat transfer fluid.

In a third embodiment, a method includes extracting heat from a nitric acid coal leaching unit and providing the extracted heat to a hydrofluoric acid coal leaching unit.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a heat integrated coal treating system in accordance with an embodiment of the present invention;

FIG. 2 is a block diagram of a heat integrated coal treating system in accordance with another embodiment of the present invention; and

FIG. 3 is a flowchart of a process for heat integrated chemical treating and in accordance with an embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the invention include a heat integrated coal treating system having a two-stage coal treating process. The treating process may also be referred to as a coal “cleaning” process. In one embodiment, the two-stage treating process (hereinafter referred to as “cleaning” process) may include a hydrofluoric (HF) reactor and a nitric acid (HNO₃) reactor. Heat may be extracted from the HNO₃ reactor and provided to the HF reactor, such as through use of a fluid and a jacket, to enhance the kinetics of the reaction in the HF reactor. In other words, the fluid acts as a heat transfer medium as it flows between the two reactors. In other embodiments, a heat exchanger may be used to add or more heat to the heated fluid before providing the heated fluid to the HF reactor.

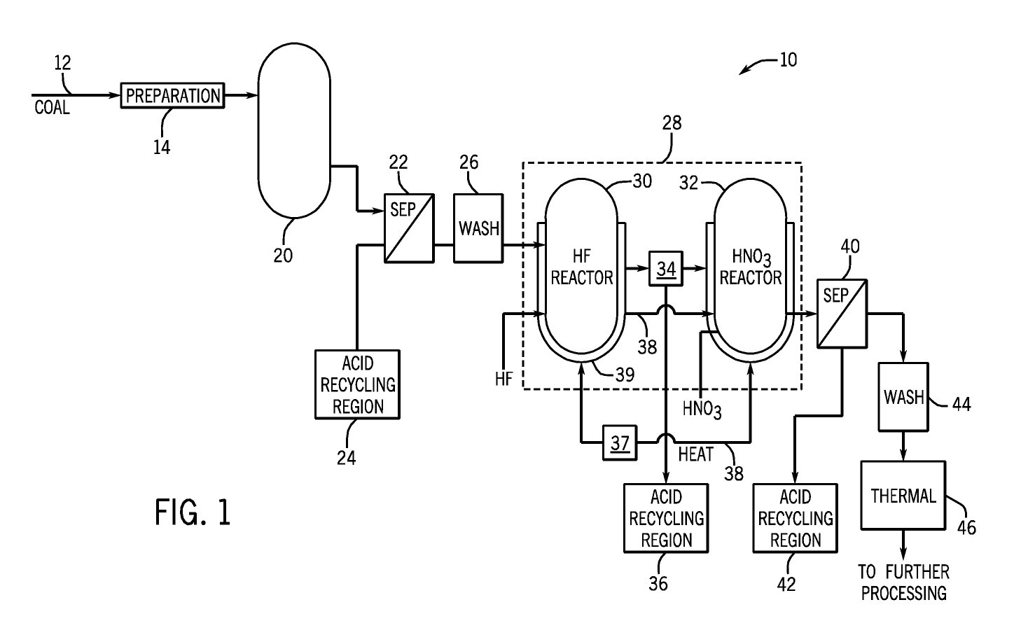

FIG. 1 depicts a heat integrated coal treating system 10 in accordance with an embodiment of the present invention. The system 10 may receive a coal feed 12 having various impurities and unwanted materials mixed in the coal feed 12. For example, such impurities and unwanted materials may include silica, alumina, sulfur, pyrite, halogens, etc. Depending on the embodiment, the system 10 described herein may remove some or all of the impurities and unwanted materials from the coal feed 12. That is, any combination of the units and processes having the integrated heat system of the coal treating system 10 described below may be implemented in any particular embodiments.

The coal feed 12 may be prepared before cleaning in a preparation unit 14. The preparation unit 14 may include one or multiple units in parallel or sequential arrangement. Such preparation may include a separation unit, a dryer, a physical preparation unit, or any combination thereof. The separation unit may include removing minerals (e.g., gangue) or other materials from the coal using any suitable physical separation apparatus. The dryer may remove some or all of the moisture inherent in the coal feed. The physical preparation unit may physically process the coal feed 12 by grinding, chopping, milling, shredding, pulverizing, briquetting, or palletizing the coal in the feed 12. The physical preparation unit may be configured to physically process to the coal to a desired size and/or shape.

After preparation, the prepared coal feed 12 may be passed to a pre-leaching unit 20. The pre-leaching unit 20 may leach the coal with a mild acid leach, such as hydrochloric acid (HCl). The pre-leaching unit 20 may partially of fully remove calcium and/or magnesium from the coal feed 12. Such removal may be used when the reduction of these metals is desirable to prevent reaction of calcium and magnesium ions with fluorides in the acid leach. After pre-leach, the coal feed 12 may be passed to a second separating unit 22 where the spent acid and other materials may be separated from the coal feed 12. The spent acids from the pre-leach may be sent to an acids regeneration and/or recycling system 24. The coal feed 12 may also be provided to a washing unit 26 to further remove any other acids or other material from the coal feed 12.

The coal may then be provided to a two-stage chemical cleaning process 28 having heat integration, such that heat is transferred from one stage to another stage. The two-stage chemical cleaning process 28 may include a first stage that includes leaching using hydrofluoric acid (HF), in an HF reactor 30, and a second stage that includes leaching using nitric acid (HNO₃), in an HNO₃ reactor 32. The HF reactor 30 may combine the hydrofluoric acid and coal feed 12 from the washing unit 26 to leach some or all of the ash compounds, such as silica and alumina, from the coal feed 12. The HF reactor 30 may be heated to increase the kinetics of the leaching reaction. In one embodiment, the reaction in the HF reactor 30 may be performed at about 150 degrees F.

After the first stage HF reactor 30, the coal feed 12 may be provided to a separation unit 34 to remove spent acid from the coal feed 12. The spent acid may be provided to an acids recycling and/or regeneration unit 36. The coal feed 12 is then provided to the second stage, i.e., the HNO₃ reactor 32. The HNO₃ reactor may combine nitric acid with the coal feed 12 from the first stage to remove sulfur from the coal.

The reaction in the HNO₃ reactor 32 may be more exothermic than the reaction in the HF reactor 30 and produce usable heat. As shown by line 38, the heat produced from the HNO₃ reactor 32 may be provided to the HF reactor 30 to provide some or all of the heat used by the HF reactor 30. In some embodiments, the heat from the HNO₃ reactor 32 may be transferred to the HF reactor 30 via a fluid, such as water, steam, etc, flowing through line 38 to a jacket 39 (e.g., a hollow fluid cavity surrounding or lining the reactor chamber) or other outer enclosure of the reactor 30. In other embodiments, the heat from the HNO₃ reactor 32 may be used indirectly to power a heating device coupled to the HF reactor 30. In some embodiments, the fluid may be circulated between the HF reactor 30 and the HNO₃ reactor 32. In other embodiments, heat may be transferred from the HF reactor 30 to the HNO₃ reactor 32, and from the HNO₃ reactor 32 to the HF reactor 30, as the fluid circulates. Thus heat may be added or removed from either reactor 30 and 32 depending on the reactions occurring in each reactor. Further, in yet other embodiments, a third, fourth, or additional acid leaching reactors may be included and may transfer heat to and from the fluid in the manner described above.

The line 38 may include a control system having control components 37 to control and regulate the fluid flow (e.g., flow rate) between the reactors 30 and 32 and the heating rate (and cooling rate) of each reactor 30 and 32. For example, the control components 37 include may include pumps, valves, sensors, controllers, and computers to circulate and regulate the flow. In some embodiments, the control components 37 may control and regulate the flow based on temperature feedback, pressure feedback, flow rate, or any other parameter of the reactor 30, the reactor 32, and/or the fluid.

In other embodiments, the two-stage chemical cleaning process 28 may include the HNO₃ reactor 32 in the first stage and the HF reactor 30 in the second stage. In such an embodiment, the coal may be undergo leaching via HNO₃ in the first stage and then may be provided to the HF reactor 30. In such embodiment, however, heat may be provided from the HNO₃ reactor 32 to the HF reactor 30 as described above.

After leaving the two-stage chemical cleaning process 28, the coal feed 12 may be passed to a separation unit 40. The separation unit 40 may remove spent acid from the coal feed 12, and the acid removed by the separation unit 40 may be provided to an acids recycling and or regeneration system 42. As will be appreciated, the acids recycling and regeneration systems 26, 36, and 42 may a single system for treated the removed acids or may be different systems for specific treatment of the acids removed from each process.

The coal feed 12 may be provided to any one or combination of units, such as a washing unit 44 and/or a thermal treatment 46. For example, the washing unit 44 may wash the coal with water or other fluids to remove remnant acids or other materials from the coal. The thermal treatment unit 46 may bake the coal at a temperature sufficient to remove halogens from the coal but prevent removal of hydrocarbon volatiles. The thermal treatment 46 may also include treatment of the coal feed 12 with a sweep gas, such as an inert gas, to facilitate removal of halogens from the coal feed 12. After removal of the coal feed 12, the coal may be passed to further processing, such as power generation system using the coal as some or all of the feedstock. For example, the cleaned coal may be provided to a combustion system, a gasification system, an integrated gasification combined cycle (IGCC) system, liquefaction, coking, or any suitable process.

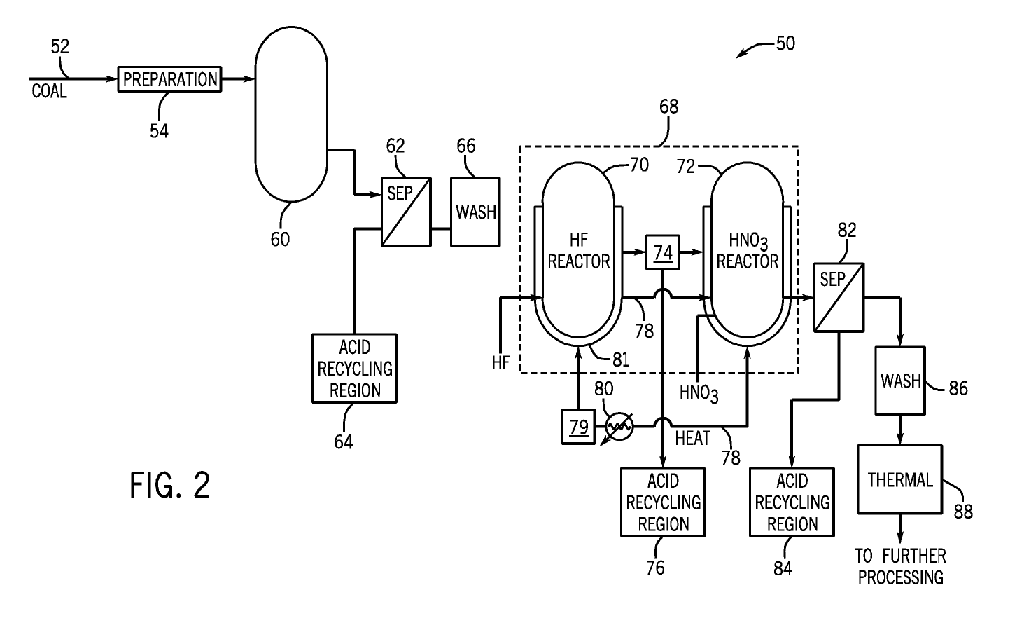

FIG. 2 depicts a heat integrated coal treating system 50 in accordance with another embodiment of the present invention. A coal feed 52 having various impurities and unwanted materials mixed in the coal feed 52 may be provided to the system 50. As noted above, such impurities and unwanted materials may include silica, alumina, vanadium, sulfur, pyrite, halogens, etc. Depending on the embodiment, the system 50 described below may remove some or all of the impurities and unwanted materials from the coal feed 52. That is, any combination of the units and processes having the integrated heat system of the coal treating system 50 described below may be implemented in any particular embodiments.

As described above, the coal feed 52 may be prepared before cleaning in a preparation unit 54. The preparation unit 54 may include one or multiple units in parallel or sequential arrangement. Such preparation may include a separation unit, a dryer, a physical preparation unit, or any combination thereof. The separation unit may include removing minerals (e.g., gangue) or other materials from the coal using any suitable physical separation apparatus, and the dryer may remove some or all of the moisture inherent in the coal feed 12. As also described above, the physical preparation unit may physically process the coal feed 52 by grinding, chopping, milling, shredding, pulverizing, briquetting, or palletizing the coal in the feed 52. The physical preparation unit may be configured to physically process to the coal to a desired size and/or shape.

As mentioned above, after preparation the coal feed 52 may be passed to a pre-leaching unit 60. The pre-leaching unit 60 may leach the coal with a mild acid leach, such as hydrochloric acid (HCl). The pre-leaching unit 60 may partially of fully remove calcium and/or magnesium from the coal feed 52. After pre-leach, the coal feed 52 may be passed to a second separating unit 62 where the spent acid and other materials may be separated from the coal feed 52. The spent acids from the pre-leach may be sent to an acids regeneration and/or recycling system 64. The coal feed 52 may also be provided to a washing unit 66 to further remove any other acids or other material from the coal feed 52.

The system 50 may include a two-stage chemical cleaning process 68 with heat integration to clean the coal feed 52. The two-stage chemical cleaning process 68 may include a first stage that includes leaching using hydrofluoric acid (HF), in an HF reactor 70, and a second stage that includes leaching using nitric acid (HNO₃), in an HNO₃ reactor 72. The HF reactor 70 may combine the hydrofluoric acid and coal feed 52 from the washing unit 66 to leach some or all of the ash compounds, such as silica and alumina, from the coal feed 52. The HF reactor 70 may be heated to increase the kinetics of the leaching reaction. In one embodiment, the reaction in the HF reactor 70 may be performed at about 150 degrees F.

After the first stage HF reactor 70, the coal feed 52 may be provided to a separation unit 74 to remove spent acid from the coal feed 52. The spent acid may be provided to an acids recycling and/or regeneration unit 76. The coal feed 52 is then provided to the second stage, i.e., the HNO₃ reactor 72. The HNO₃ reactor may combine nitric acid with the coal feed 52 from the first stage to remove sulfur from the coal.

The reaction in the HNO₃ reactor 72 may be more exothermic than the reaction in the HF reactor 70 and produce usable heat. As shown by line 78, the heat produced from the HNO₃ reactor 72 may be provided via a fluid to a heat exchange 80, and then to the HF reactor 70, to provide some or all of the heat used by the HF reactor 70. The heat exchanger 80 may provide control of the heat provided from the HNO₃ reactor 72 to the HF reactor 70. For example, the heat exchanger 80 may remove excess heat from the heated fluid from the HNO₃ reactor if the excess heat is not used for the HF reactor 70. In another example, the heat exchanger 80 may add heat to the heated fluid from the HNO₃ reactor if the heated fluid does not provide enough heat for the HF reactor 70. In some embodiments, the heat from the HNO₃ reactor 72 may be transferred to the HF reactor 70 via a fluid, such as water, steam, etc., provided through the line 78 to a jacket 81 (e.g., a hollow fluid cavity surrounding or lining the reactor chamber) or other outer enclosure of the reactor 70. In some embodiments, the fluid may be circulated between the HF reactor 70 and the HNO₃ reactor 72. In other embodiments, heat may be transferred from the HF reactor 70 to the HNO₃ reactor 72, and from the HNO₃ reactor 72 to the HF reactor 70, as the fluid circulates. Thus heat may be added or removed from either reactor 70 and 72 depending on the reactions occurring in each reactor. Further, in yet other embodiments, a third, fourth, or additional acid leaching reactors may be included and may transfer heat to and from the fluid in the manner described above.

The line 78 may include or be coupled to a control system having control components 79 to control and regulate the fluid flow (e.g., flow rate) between the reactors 70 and 72 and the heating rate (and cooling rate) of each reactor 70 and 72. For example, the control components 79 include may include pumps, valves, sensors, controllers, and computers to circulate and regulate the flow. In some embodiments, the control components 79 may control and regulate the flow based on temperature feedback, pressure feedback, flow rate, or any other parameter of the reactor 70, the reactor 72, and/or the fluid.

As mentioned above, in other embodiments, the two-stage chemical cleaning process 68 may include the HNO₃ reactor 72 in the first stage and the HF reactor 70 in the second stage. In such an embodiment, the coal may be undergo leaching via HNO₃ in the first stage and then may be provided to the HF reactor 70 for leaching via HF in the second stage. In such embodiment, however, heat may be provided from the HNO₃ reactor 72 to the HF reactor 70 as described above, such as through heat exchanger 80.

As described above, after leaving the two-stage chemical cleaning process 68, the coal feed 52 may be passed to a separation unit 82. The separation unit 82 may remove spent acid from the coal feed 12, and the acid removed by the separation unit 68 may be provided to an acids recycling and or regeneration system 84. As will be appreciated, the acids recycling and regeneration systems 66, 76, and 84 may a single system for treated the removed acids or may be different systems for specific treatment of the acids removed from each process.

As also mentioned above, the coal feed 52 may be provided to any one or combination of units, such as a washing unit 86 and/or a thermal treatment 88. For example, the washing unit 86 may wash the coal with water or other fluids to remove remnant acids or other materials from the coal. The thermal treatment unit 88 may bake the coal at a temperature sufficient to remove halogens from the coal but prevent removal of hydrocarbon volatiles. The thermal treatment 88 may also include treatment of the coal feed 52 with a sweep gas, such as an inert gas, to facilitate removal of halogens from the coal feed 52. Again, after removal of the coal feed 12, the coal may be passed to further processing, such as power generation system using the coal as some or all of the feedstock. For example, the cleaned coal may be provided to a combustion system, a gasification system, an integrated gasification combined cycle (IGCC) system, liquefaction, coking, or any suitable process.

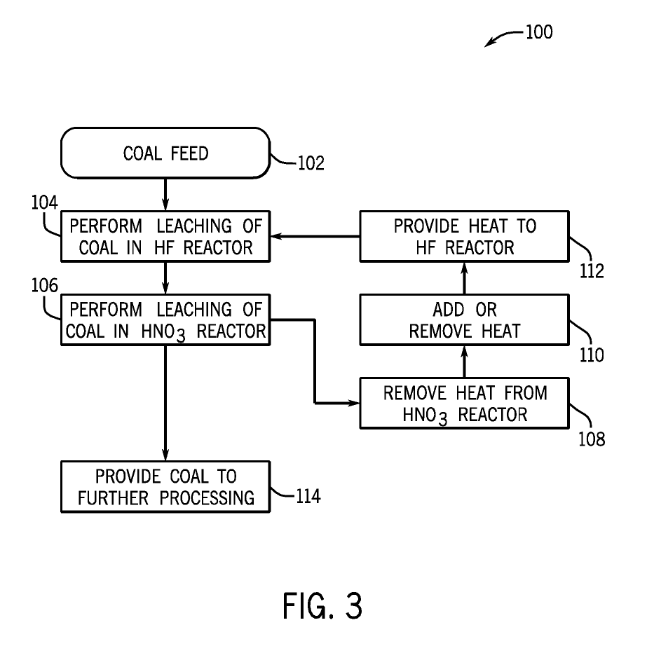

FIG. 3 depicts a process 100 for the integrated heat chemical treating described above and in accordance with an embodiment of the present invention. The process described in FIG. 3 may be implemented through any suitable variety of control devices and systems, such as valves, pipes, sensors, process controllers, etc. The process may begin with a coal feed 102 that may have been prepared and pre-leached as described above. Initially, the first stage of the chemical cleaning (e.g., leaching) may be performed in the HF reactor (block 104), e.g., HF reactor 30 or 70. After the first stage, the coal may be separating from the spent acid and provided to the second stage. The second stage of the chemical cleaning (e.g., leaching) may be performed in the HNO₃ reactor (block 106), e.g., HNO₃ reactor 32 or 72.

As described, heat may be removed from the HNO₃ reactor (block 108), such as by a fluid (e.g., water, steam, etc.). In some embodiments, the heat may be added or removed to the heated fluid (block 110), such as through a heat exchanger (e.g., heat exchanger 72). In other embodiments, the heated fluid carrying heat removed from the HNO₃ may remain unprocessed. The heat from the HNO₃ reactor may then be provided to the HF reactor (block 112), such as by providing the heated fluid directly to the reactor (e.g., through a jacket of the HF reactor). In other embodiments, as noted above, the heat may be used indirectly, such as by powering a heating apparatus, e.g., a boiler, coupled to the HF reactor. As illustrated, cleaned coal from the HNO₃ reactor may be output to further processing (block 114).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A coal treating system, comprising:
a hydrofluoric acid reactor;
a nitric acid reactor coupled to the hydrofluoric reactor; and
a fluid exchanging heat between the hydrofluoric acid reactor and the nitric acid reactor.

2. The system of claim 1, comprising a heat exchanger disposed between the hydrofluoric acid reactor and the nitric acid reactor.

3. The system of claim 1, wherein the heat exchanger is configured to remove heat from the fluid.

4. The system of claim 1, wherein the heat exchanger is configured to add heat to the fluid.

5. The system of claim 1, wherein the hydrofluoric acid reactor comprises a jacket and the fluid is provided to the jacket.

6. The system of claim 1, wherein the coal treating system comprises a first separator configured to remove spent acid from an output of the hydrofluoric acid reactor.

7. The system of claim 1, wherein the hydrofluoric acid reactor is configured to remove at least one of silicate, alumina, or vanadium from coal.

8. The system of claim 1, wherein the nitric acid reactor is configured to remove sulfur from coal.

9. A coal treating system, comprising:
a control system configured to control a multi-stage coal treating system, wherein the multi-stage coal treating system comprises:
a first stage comprising a first leaching unit configured to perform a first acid leaching process with a first acid;
a second stage comprising a second leaching unit configured to perform a second acid leaching process with a second acid; and
a heat transfer fluid flowing between the first stage and the second stage;
wherein the control system controls the heating rate of the first stage, the second stage, or both, and the flow rate of the heat transfer fluid.

10. The system of claim 9, wherein the multi-stage coal treating system comprises a third stage configured to perform a third acid leaching process.

11. The system of claim 9, wherein the first leaching unit is configured to remove at least one of silica, alumina, or vanadium from coal.

12. The system of claim 9, wherein the second leaching unit is configured to remove sulfur from coal.

13. The system of claim 9, wherein the first acid comprises hydrofluoric acid.

14. The system of claim 9, wherein the second acid comprises nitric acid.

15. The system of claim 9, wherein the heat is transferred via a fluid.

16. A method, comprising:
extracting heat from a nitric acid coal leaching unit; and
providing the extracted heat to a hydrofluoric acid coal leaching unit.

17. The method of claim 16, wherein extracting heat comprises heating a fluid.

18. The method of claim 17, wherein providing the extracted heat comprises providing the heated fluid to the hydrofluoric acid coal leaching unit.

19. The method of claim 18, comprising heating the fluid in a heat exchanger before providing the heated fluid to the hydrofluoric acid coal leaching unit.

20. The method of claim 19, comprising heating the hydrofluoric acid coal leaching unit with the heated fluid.
